(19) United States
(12) Patent Application Publication
(10) Pub. No.: US 2020/0139425 A1
(43) Pub. Date: May 7, 2020

(54) SETTING TOOL FOR A BLIND FASTENER, SETTING METHOD AND SUITABLE BLIND FASTENER

(71) Applicant: ERIS, FLOURENS (FR)

(72) Inventors: Pierre AURIOL, TOULOUSE (FR); Jean-Luc MARQUEZ, SAINT LEON (FR); Vincent BRANDON, BALMA (FR); Bertrand JEHENNE, SAINTE FOY D'AIGREFEUILLE (FR)

(21) Appl. No.: 16/619,489

(22) PCT Filed: Jun. 8, 2018
(86) PCT No.: PCT/FR2018/051338

§ 371 Date: Dec. 5, 2019

(30) Foreign Application Priority Data
Jun. 9, 2017 (FR) 1755177

(51) Int. Cl. B21J 15/28; B21J 15/04; F16B 19/10

(52) U.S. Cl. CPC B21J 15/285; B21J 15/043; B21J 15/142; F16B 19/1072; F16B 19/1063; F16B 19/1054

(57) ABSTRACT

Disclosed is a blind fastener including a core bolt, a body and a blind side clamp on the core bolt insertable through an aperture, where moving the core bolt relative to the body forms an enlarged bearing surface against a back surface. The fastener includes an extension from the body with a wrenching surface and an undercut between the body and the wrenching surface that is optionally configured to break when torque equal to the sum of an application specified minimum installed seated torque and a manufacturing failure torque tolerance for the undercut is applied. Also disclosed is a method of dressing the installed fastener including machining through the top surface of the fastener along a longitudinal axis of the core bolt of the fastener and the extension that extends from a body of the fastener until intersecting the undercut between the extension to remove the extension.

### FIELD OF THE INVENTION

The present invention relates to the field of blind fasteners and namely to the setting tools allowing to ensure their setting in the best conditions.

### DESCRIPTION OF THE PRIOR ART

Until now, the majority of aeronautical primary structures (such as the fuselage, the wings, the empennages, etc.) are assembled by screwed and/or swaged links. The screws and the fasteners called “lockbolts” used are characterized by “flush” heads that protrude only very slightly from the structure and do not have a hollow recess.

Today, the field of aeronautical fasteners must nevertheless be able to adapt to new requirements with regard to the assemblies of aeronautical structures. The use of composite materials in the primary structural zones requires the design of new structural fasteners with high mechanical performance without damaging the composite material. Moreover, the high rates of production require resorting to the automation of the assembly of primary structures, such as sections of fuselage, or wing/fuselage junctions. Aircraft manufacturers are therefore currently turning to fasteners of the “blind” or “one-side” type to ensure the primary junctions that is to say with strong stresses of aeronautical assemblies. By their design, the setting of blind fasteners has the advantage of being relatively automatable. However, it requires additional means in order to not damage the composite materials receiving said fasteners which must be aerodynamic and viable.

A blind fastener is conventionally composed of a central rod—or screw—allowing, by the rotation or the traction of the latter, to deform an end of an outer body on the blind side of the assembly in order to form a bulb. This outer body is fitted onto the rod and can be in one piece or composed of a plurality of portions, including a deformable mobile portion.

A blind fastener thus has the advantage of being installed in a bore while only having access to a single side of the assembly. The outer body comprises a head bearing against the assembly on the accessible side. The rod is conventionally preformed with a rupture groove so that once a predefined stress threshold has been reached, the rod breaks. This feature prevents the rod from remaining protruding, once the fastener has been set.

The use of blind fasteners on external primary structures nevertheless raises the issue of controlling the installation without having access to the blind side. A good installation is distinguished from a poor one, namely by the level of compression induced in the assembly. The correct formation of the bulb and the non-deformation of the head are also criteria.

The tension installed in the assembly (compression stress in the assembly and tensile stress in the fastener) must be at least 50% of the theoretical axial ultimate tensile strength of the fastener. For example, for a fastener, the theoretical ultimate tensile strength of which is 1335 daN, the tension installed must be at least 667 daN. The control of a proper installation, thus of a proper level of compression of the sheets, must be able to be put in place in the installation of a blind fastener.

Another parameter is that the second plateau namely the elastic limit of the fastener must be equal to 75% of the theoretical axial ultimate tensile strength.

Moreover, the conventional structural blind fasteners generally have a series of recesses (cruciform, notched, for the most common) on the head of the outer body allowing to carry out the functions of retention during the setting and sometimes of control. The whole fastener is maintained immobile by the fixed part of the setting equipment, via said recesses. However, this type of recesses has a significant aerodynamic impact that it is necessary to take into account when these fasteners are intended for external aeronautical structures. In other words, the installation of a blind fastener can occur to the detriment of the aerodynamic (aerodynamic fingerprint, drag) and cosmetic (visual appearance after painting) qualities of the head of the fastener.

The blind fasteners with a countersunk head currently available on the market, thus have various hollow recesses necessary for the setting of the fastener. There are also blind fasteners having protruding recesses.

One alternative to the presence of recesses is described in the document U.S. Pat. No. 2,282,711. This document describes a blind fastener with an outer body comprising a head equipped with a protruding but detachable portion. The head has a geometry that allows it to cooperate with a tool to be maintained during the setting. Once the fastener has been set and the rod broken, the protruding head portion is then detached by the application of a torsional stress on the head.

The document WO2013043673 describes a blind-fastener element comprising a central bolt, a body and a blind retaining element (or sheath) placed on the central bolt, capable of being inserted through an opening, the movement of the central bolt with respect to the body causing an increase in the surface of contact with a rear surface. The fastener element comprises an extension of the body provided with a clamping surface and with an undercut formed between the body and the clamping surface, which is optionally designed to break when a torque is applied equal to the sum of the minimum placement torque specified by the use and the maximum manufacturing-tolerance failure torque for the undercut.

In this second document, a method is also described for installing a fastener that uses the detachable head part to verify the installed torque by applying a torsion onto the detachable part and by separating the extension from the body by breaking the part fragilized for this purpose. The torsion applied is thus greater than the installed minimum torque specified for the fastener.

If the fastener installed rotates in the opening before the extension is separated from the body, the fastener is removed and replaced. Nevertheless, the use of a torque installed in the fastener as a parameter for verification of proper assembly cannot be considered to be sufficient. Indeed, the torque installed in the fastener depends on the conditions of friction which is variable according to the materials assembled, on the possible presence of lubricant or of any material interposed between the fastener and the assembly. This installed torque also depends on the diameter of the bulb obtained by deformation.

The document also describes a method for dressing the fastener element put in place, comprising machining through the upper surface of the fastener element, along a longitudinal axis of the central bolt of the fastener element and of the extension going from the outer body of the fastener element to the intersection with the undercut formed between the outer body and the extension, to remove the extension.

The document EP2505855 describes a blind fastener comprising a body with at a first end a visible face, through which passes a bore receiving a rod, a first end of which protrudes with respect to the visible face and the other end of which comprises a head capable of deforming a deformation zone when the rod is translated, the visible face comprising retention means for immobilizing the blind fastener in rotation with respect to a tool used to drive the rod in rotation, said retention means comprising at least one lug added at the visible face and protruding with respect to the latter. This lug of the fastener is connected to the body by a junction zone capable of breaking when the lug undergoes a stress greater than a given threshold. A preferred embodiment proposes a configuration with a plurality of lugs in order to distribute the stresses. Likewise, a setting tool cooperating with said lugs is described.

It is difficult in this case to guarantee the rupture of all of the lugs. The variability in the counter-torque upon installation makes it so that the lug or the lugs must be subject to specific dimensioning that is difficult to define. Moreover, the plurality of lugs requires the management of as many parts. Finally the translation of the rod defines a random positioning of the rupture zone of the rod according to the variable thicknesses of the assemblies. Given the variation in the thicknesses to be clamped, it is impossible to not provide a systematic shaving phase.

Indeed, even though such fasteners do not have recesses, they can on the contrary have protruding volumes resulting from the rupture. Thus, whether for this fastener or for those described in the previously cited documents, the unpredictability related to the rupture with regard to the fastener part remaining in place and protruding with respect to the surface of the elements to be assembled, can require the implementation of a machining phase for eliminating any protrusion.

### BRIEF DESCRIPTION OF THE INVENTION

Starting from this state of affairs, the applicant carried out research, the goal of which was a tool for setting a blind fastener like that described namely comprising a detachable outer-body head portion in order to benefit from the advantages of such a fastener without having the disadvantages thereof.

This research lead to the design and to the realization of a novel setting tool allowing the setting of such fasteners in better conditions.

The tool of the invention ensures

the setting of a blind fastener comprising a rod onto which an outer body is fitted,

the outer body comprising a head and a detachable portion connected to said head by means of a thinned portion of the outer body,

the outer body comprising one or more parts,

said outer body comprising a deformable portion for creating a bulb under the action of the rod,

the action of the rod capable of being by rotation or by traction,

the rod comprising a rupture groove that breaks from a predefined stress threshold,

the setting method involving carrying out the following operations:
positioning the fastener in a hole passing through an assembly,
maintaining the fastener in the hole,
creating a bulb for fastening the assembly,
rupture of the rod,
rupture of the detachable portion of the head of the outer body.

The setting tool is remarkable in that it comprises a setting member cooperating with said rod and a setting-verification member cooperating with said head of the outer body,
the setting member having an action on the rod for creating the bulb until the rupture of the rod at the rupture groove,
the setting-verification member retaining the detachable portion of the head of the outer body during the action of the setting member on the rod,
the verification member subjecting the detachable portion of the head of the outer body to a torsional stress by driving in rotation of the impact type which allows the production of a significant dynamic stress produced in a very short time by subjecting said detachable portion of the head of the outer body to at least one impact in a direction of rotation for breaking the thinned portion of the outer body, the rupture resulting from a proper installation and the absence of rupture resulting from a poor installation.

Such a setting tool allows to implement a control after setting (fool-proofing) of the proper installation according to the desired criteria of such a blind fastener without a recess by ensuring the proper placement of the fastening by rupture of the detachable part of the head of the outer body.

Such a tool also allows a setting in good conditions with regard to the rupture of the detachable parts. The technology of driving via impact avoids any protrusion requiring an operation of dressing or of shaving. Indeed, impact driving ensures a clean break of the detachable part. Moreover, by subjecting the detachable part of the head of the outer body to a localized torsional stress according to a very significant torque, this driving technology allows to better take into account the tension installed in the assembly and thus better make sure of the latter by the rupture of the detachable part.

The visual absence of a protruding element thus guarantees a proper setting. On the contrary, if the detachable part of the head of the outer body remains present, the setting was not carried out in good conditions like an incorrect tension installed, an incorrectly formed bulb or a deformed head. It is thus possible to ensure a visual verification of proper setting for each fastener from outside the assembly.

Impact driving is known in the field of the nut runners called impact wrenches. In certain embodiments, it involves a notion of angle of “free” rotation which allows to guarantee an impact or rather a minimum dynamic stress produced in a very short time. This movement means is used for operations of screwing and unscrewing bolts requiring a high power. It is not known as a means for breaking an element for verification of the proper setting of a fastener. This is therefore a novel use of a known means. Moreover, impact driving is not recommended in aeronautical uses since the stress in the fastener is poorly controlled due to the use of impacts.

A tool combining a setting tool acting on a blind-fastener rod and a verification member consisting of an impact-driving means, the goal of which is to obtain a rupture, is also not known.

According to another particularly advantageous feature of the invention, the setting member ensures a rotation of the rod for creating the bulb by screwing until rupture of the rod at its rupture groove. The implementation of a stress by torsion avoids the axial movement in translation of the rod and ensures a precise positioning of the rupture zone as close as possible to the surface of the assembly and despite the possible variations in the thickness of the assembly. While such a feature participates in obtaining a fastener set with a small aerodynamic fingerprint and a smooth cosmetic appearance, it generates a new difficulty. Indeed, the rupture of the portion of the outer body connecting the detachable part to the rest of the outer body is in no way obvious. During the first screwing phase, the outer body must be capable of not rotating. The detachable part of the head of the outer body thus undergoes a counter-torque. However, the unpredictability of a screwed fastener (due to the materials, the friction, etc. . . . ) means that the torque transmitted to the outer body during the clamping by screwing (counter-torque) can vary from 30 to 70% (thus constituting a repeatability defect).

The variability in the setting torques and the problem of the slippage during the second rupture are technical problems that have not been raised and a fortiori solved by the prior art.

The applicant carried out research in order to obtain the desired technical effect. The curves illustrated by the drawing of FIG. 4 represent stresses during a setting.

The two curves shown in short dashes and located under the upper curve are the two curves representing the extremes of the unpredictability of the counter-torque undergone by the thinned portion connecting the detachable portion to the head of the outer body. These two curves depend on the motor torque shown by said upper curve.

S1 corresponds to the stress threshold starting from which the rod breaks and S2 corresponds to the stress threshold starting from which the thinned linking portion between the detachable portion and the head of the outer body breaks.

The first motor torque intended to obtain a clamping stress, the breaking of the rod at S1, its stoppage and the second motor torque intended to obtain the breakage of said thinned portion at S2 if the clamping has indeed been carried out can be clearly seen on this curve.

There must therefore be a thickness of material for the thinned linking portion (between the detachable part of the head of the outer body and said head of the outer body) sufficient to resist the counter-torque undergone by the outer body and not break despite this variation in clamping torque before rupture of the rod (this premature breaking being represented by the blackened zone). However, if the necessary torque S2 is too high, that is to say that the thinned linking part connecting the detachable portion of the head of the outer body to said head of the outer body is too oversized, it is no longer possible to detach it. The curves illustrated by FIG. 5 can thus be obtained.

It is understood that the oversizing of the thinned portion leads to an inability to break it if the means ensuring the second verification phase is not adapted. A phenomenon of slippage is produced.

This is the reason for the solution of impact driving that is to say by jolts which allows the production of a dynamic stress and to obtain the curves of FIGS. 6 and 7 illustrating two hypotheses.

For a hypothesis in which the effective clamping (dotted curve) is less than the installation torque, the curve illustrated by the drawing of FIG. 6 is obtained.

For a hypothesis in which the effective clamping is greater than the installation torque, the curve illustrated by FIG. 7 is obtained.

The use of impact driving on the detachable portion of the head of the outer body for the second phase which will be applied to the thinned linking part connecting the detachable part to the head of the outer body, allows the production of a dynamic stress. This significant stress produced in a very short time allows, while having a strong counter-torque during the first screwing phase, to carry out a rupture of the outer body during the phase of verification that the effective clamping is less or greater than the installation torque.

The implementation of impact driving is thus particularly advantageous in that it allows to have more margin on the detachable part of the head of the outer body in particular in the case in which the unpredictability of a screwed fastener makes it so that the variation in the resulting counter-torque on said head is not negligible.

A slight oversizing of the thinned portion for linking the detachable part to said head allows to resist the resulting counter-torque during the setting on said head of the outer body. The verification of the setting via an impact on a thinned zone, allows to carry out the rupture of the detachable part of the head of the outer body while ensuring the resistance (without rupture) of this detachable part during the previous setting phase.

Moreover, a rupture by impact of a thinned metallic portion allows to obtain a clean rupture without chips or burrs.

Thus, the combination of the two setting and setting-verification members in the same tool requires the resolution of a plurality of new technical problems:
maintaining the setting-verification member in position during the movement of the other,
managing the movement means capable of driving according to a movement without jolting and according to a movement with jolting, that is to say with impact,
not detaching the detachable part of the head of the outer body which undergoes a significant counter-torque during the setting,
allowing the detachment of said detachable part of the head of the outer body during the verification if the fastener is properly set,
managing two detachable elements (the detachable rod part and the detachable head part).

The control means can thus be put in place by the visual control of the fastener which has, after setting, an aerodynamic and cosmetic, smooth appearance free of any recess.

According to another particularly advantageous feature of the invention, the setting tool is remarkable in that it comprises at least one digital-control module controlling the various movements and monitoring the torques achieved for the movements of the two members for implementation of a proper installation and of implementation of a verification of the latter. The use of a digital control for monitoring two torques for the implementation of a method for setting a blind fastener is innovative.

As explained above, the proper installation of a blind fastener is characterized namely by a level of installed tension at least equal to 50% of the theoretical ultimate strength of the part.

The principle of a double groove (a rupture groove on the rod and a thinned portion of the outer body) and thus of a double rupture of the detachable parts of the fastener implemented by the tool of the invention allows to eliminate clamping recesses on the fastener head, bothersome on a cosmetic and aerodynamic level.

Moreover, this double rupture allows to control the proper installation of the fastener by means of the rupture on the head of the outer body of the fastener, a rupture which is calibrated.

Such a tool can thus guarantee the clamping of the assembly according to the standard specifications of the fastener while respecting the following constraints:
limited access to the fastener, only the head side accessible,
small aerodynamic fingerprint (desired maximum 150-micron protrusion),
smooth cosmetic appearance (called flush),
automatable setting.

Other particularly advantageous features complete, in association or not, the features of the invention described above:
the outer body of the fastener is in two parts with a mobile part being deformed under the action of the rod for creating the bulb;
the setting member is moved by an electric or pneumatic motor;
the setting-verification member is moved by an electric or pneumatic motor;
the tool comprises a single motor driving the setting member and the setting-verification member in a distinct manner by means of a suitable reduction sub-assembly;
the setting member drives the setting-verification member by means of a suitable reduction assembly.

According to another particularly advantageous feature of the invention, the verification member comprises an angle of “free” rotation that is between 60° and 240°. This angle goes beyond a simple functional play and is defined to guarantee the impact or rather a minimum dynamic stress produced in a very short time.

It is understood that this research lead to the design and to the realization of a new method implemented by said tool. Thus, another object of the invention relates to the setting method of the invention which integrates a phase of setting verification.

This method for setting a blind fastener comprising a rod onto which an outer body is fitted,

the outer body comprising a head and a detachable portion connected to said head by means of a thinned portion of the outer body,

the outer body comprising one or more parts,

said outer body comprising a deformable portion for creating a bulb under the action of the rod,

the rod comprising a rupture groove which breaks from a predefined stress threshold,

the setting method involving carrying out the following operations:
positioning the fastener in a hole passing through an assembly,
maintaining the fastener in the hole,
creating a bulb for fastening the assembly,
rupture of the rod,
rupture of the detachable portion of the head,

is remarkable in that it comprises the following operations:
driving the rod without jolts for creating the bulb until rupture of the rod at the rupture groove while retaining the detachable portion of the head of the outer body,
impact driving in rotation by producing a significant dynamic stress in a very short time, the detachable portion of the head of the outer body to exert a torsional stress for rupture of the thinned portion of the outer body, the rupture resulting from a proper installation and the absence of rupture resulting from a poor installation.

This method can be implemented by one such as that described above or a plurality of tools.

As explained above, the implementation of impact driving is particularly advantageous in that it allows to have more margin on the detachable part of the head of the outer body in particular in the case in which the unpredictability of a screwed fastener makes it so that the variation in the resulting counter-torque on said head is not negligible.

According to another particularly advantageous feature, the creation of the bulb until rupture of the rod at the rupture groove while retaining the detachable portion of the head of the outer body, is carried out by driving said rod in rotation without jolts.

According to another particularly advantageous feature, the significant stress is a stress corresponding to at least two times the stress necessary to break the thinned linking portion connecting the detachable portion to the head of the outer body and the very short time is a time of less than one second.

Another object of the invention relates to the blind fastener adapted to such a setting tool.

As explained above, this blind fastener comprises a rod onto which an outer body is fitted,

the outer body comprising a head and a detachable portion connected to said head by means of a thinned portion of the outer body,

the outer body comprising one or more parts,

said outer body comprising a deformable portion for creating a bulb under the action of the rod,

the rod comprising a head and a detachable portion of the rod head connected to said head by a rupture groove which breaks from a predefined stress threshold.

According to the invention, the blind fastener is remarkable in that said thinned portion of the outer body connecting the detachable portion of the head to said head is dimensioned in such a way as to
resist the counter-torque that it undergoes during the creation of the bulb by rotation of the rod until the rupture of the rupture groove of the rod and
break during an impact driving if the fastener is properly installed.

This dimensioning is designed while taking into account the materials used.

According to a preferred but not limiting embodiment, the fastener is remarkable in that the outer body is made of titanium and the rod is made of stainless steel or made of titanium. This association of material allows to obtain the desired rupture-stress thresholds for the fastener to be properly installed by the tool of the invention and for this installation to be able to be verified by the same tool.

According to another particularly advantageous feature of the invention, the detachable portion of the head of the rod is preformed in such a way as to form an axial support so that a movement in translation applied to the detachable portion detached from the rod head for ejection, causes a contact with the detachable portion detached from the head of the outer body and its own ejection. The ejection is thus simplified and more easily automatable. This preforming can take the form of greater dimensions, of creation of a shoulder or any other protrusion guaranteeing the driving. The presence of a shoulder on the rod of a blind fastener is known. Nevertheless, this shoulder has the novel function of implementing the ejection of the detachable part of the outer body at the same time as that of the rod.

According to another particularly advantageous feature, the detachable portion of the head of the outer body consists of a projection coming from the head of the outer body, preformed to extend the hollow core passing through the outer body and having a zone for annular linking with the head. This detachable portion does not consist of one or more lugs. In practice the rupture proposed by the annular linking zone of the detachable part is easier and easier to reproduce than a simultaneous rupture of a plurality of lugs.

The fundamental concepts of the invention that have just been disclosed above in their most elementary form, other details and features will be clearer upon reading the following description and with regard to the appended drawings, giving as a non-limiting example, an embodiment of a setting tool according to the invention.

### BRIEF DESCRIPTION OF THE DRAWINGS

FIG. 1a is a diagram of a cross-sectional side view of a first embodiment of a blind fastener according to the invention;

FIG. 1b is a diagram of a front outside view of the fastener of FIG. 1a;

FIG. 1c is a diagram of a perspective outside view of the fastener of FIG. 1a;

FIGS. 2a to 2f are diagrams of cross-sectional side views of the tool and of the fastener of FIG. 1a installed in an assembly and illustrating the steps of the setting operation implemented by the tool of the invention;

FIG. 2g is a diagram of a cross-sectional side view of a blind fastener installed by the tool of the invention;

FIG. 2h is a diagram of a front outside view of the accessible side of the fastener once installed;

FIG. 3 is a diagram of a cross-sectional side view of another embodiment of a blind fastener according to the invention;

FIG. 4 illustrates the monitoring curves of the installation parameters in the case of an effective clamping lower than the installation torque S1—calibration in the 30-70% range—counter-torque;

FIG. 5 illustrates the monitoring curves of the installation parameters in the case of an effective clamping lower than the installation torque S1—calibration outside of 30-70% range—slippage;

FIG. 6 illustrates the monitoring curves of the installation parameters in the case of an effective clamping lower than the installation torque S1—impact rupture—no slippage;

FIG. 7 illustrates the monitoring curves of the installation parameters in the case of an effective clamping greater than the installation torque S1—impact rupture—no slippage.

### DESCRIPTION OF THE PREFERRED EMBODIMENTS

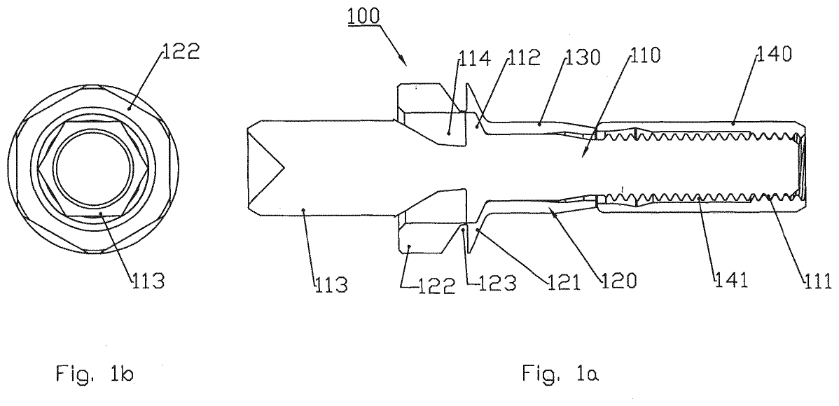

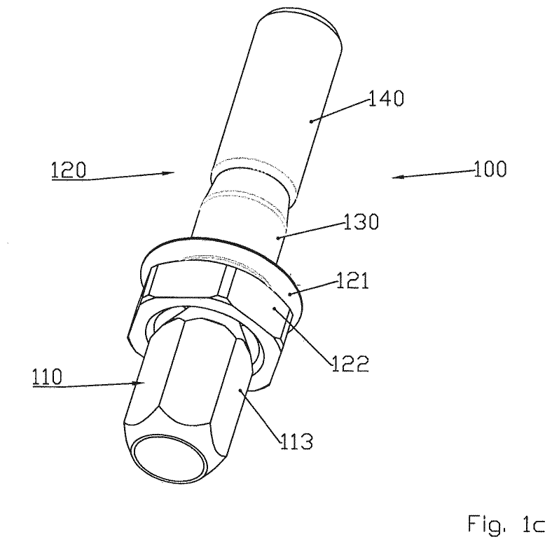

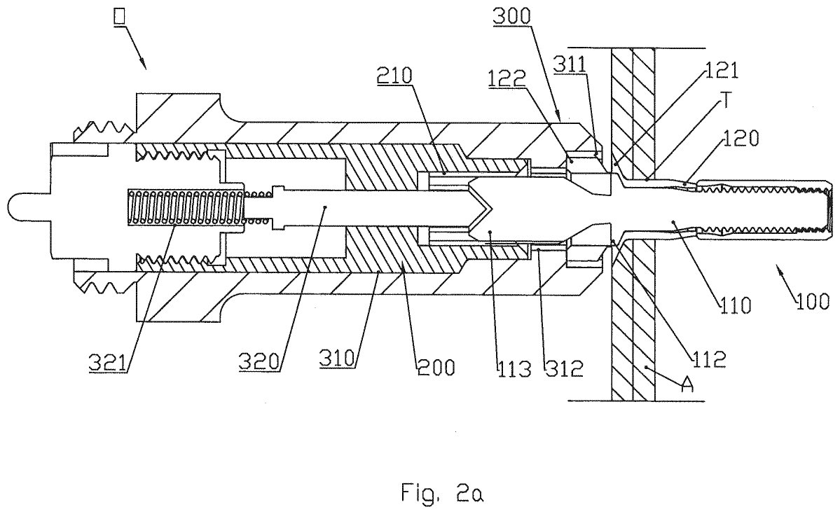

As illustrated in the drawings of FIGS. 1a, 1b and 1c, the blind fastener labelled 100 as a whole comprises a rod 110 onto which an outer body 120 is fitted.

The outer body 120 is thus hollow and comprises a head 121 countersunk and equipped with a detachable portion 122. This outer body 120 comprises a plurality of parts:
a fixed portion 130 equipped with said head 121 and bearing on the accessible face of the assembly to be carried out,
a mobile and deformable portion 140 for creating a bulb under the action of the rod 110.

To do this, this mobile and deformable portion 140 is preformed with a hollow core 141 that passes all the way through, a portion 142 of which has an inner thread. An end of the rod 110 is preformed with a threaded portion 111 and is screwed into the portion 142 with an inner thread of the mobile and deformable portion 140.

A thinned annular linking portion defined by a rupture groove 123 connects the detachable portion 122 to the head 121 of the outer body 120. This thinned rupture portion 123 of the outer body 120 breaks from a predefined stress threshold S2.

The rod 110 is positioned in the hollow core of the outer body 120 and comprises a rod 110 head 112 countersunk and equipped with detachable portion 113, a thinned portion defined by a rupture groove 114 connects said detachable portion 113 to the rod 110 head 112. This thinned portion 114 of the rod breaks starting from another predefined stress threshold S1 lower or greater than that S2 defined for the rupture of the thinned portion 123.

The detachable portion 113 of the head 112 of the rod 110 has a smaller diameter than and protrudes with respect to the detachable portion 122 of the head 121 of the outer body 120.

These two detachable portions 122 and 113 have according to the non-limiting embodiment illustrated, a hexagonal outer profile facilitating their association with tools having a suitable recess. Of course, other profiles, mismatched or not, are possible.

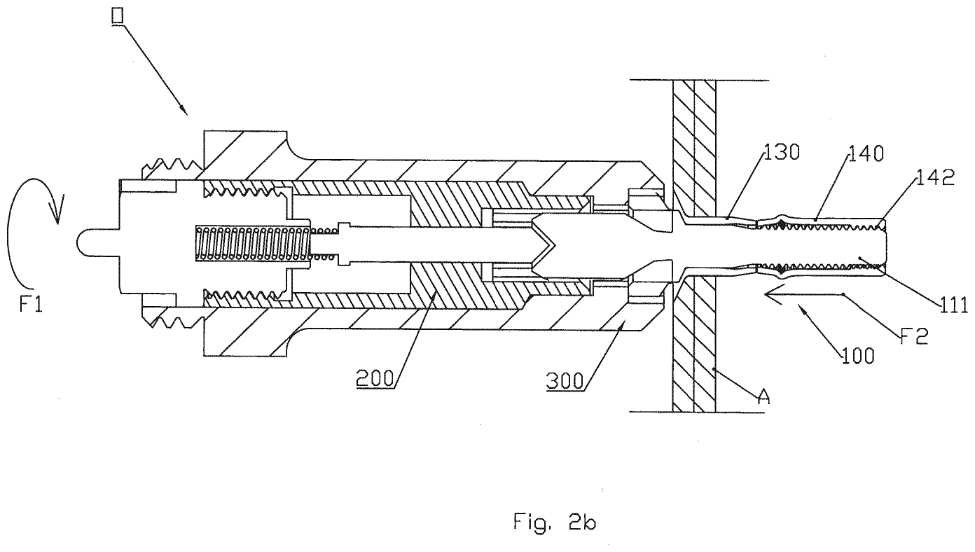

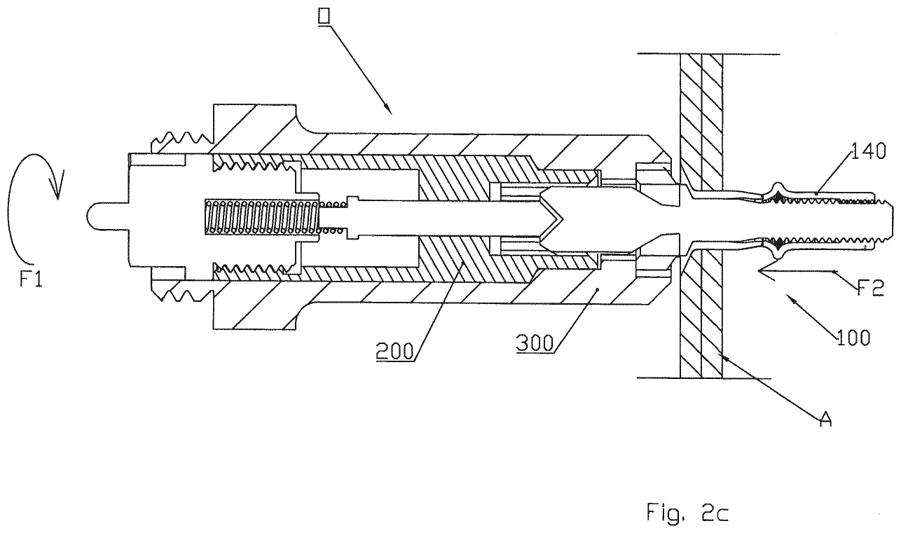

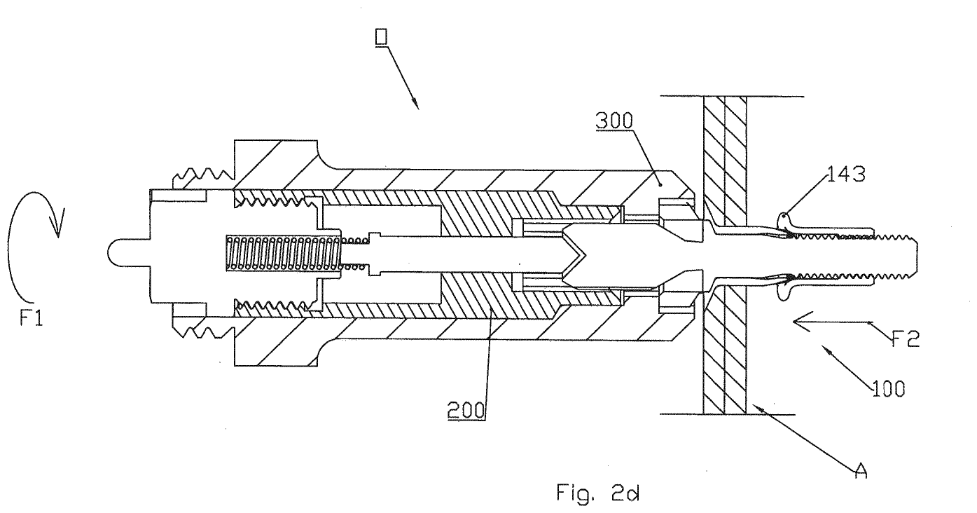

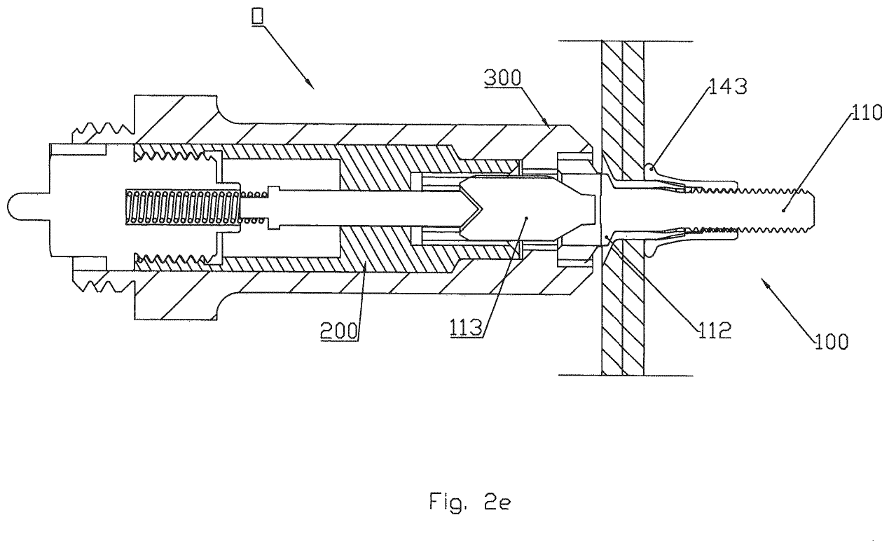

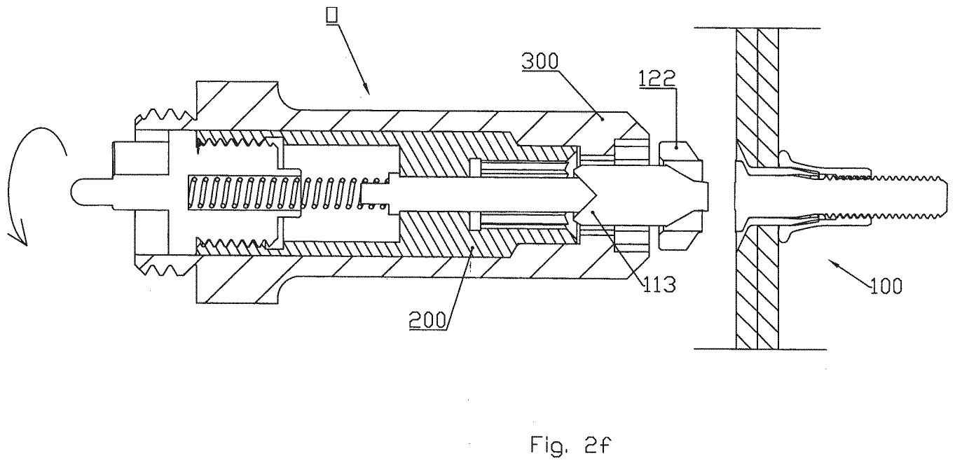

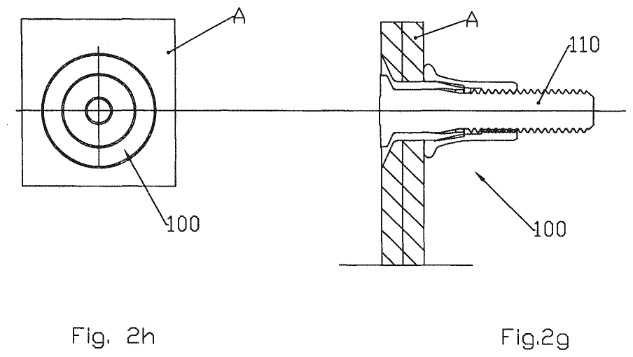

As illustrated in the drawing of FIG. 2a, in order to carry out the proper setting and make sure of the latter, a tool O cooperates with the fastener 100 installed in a through-hole T with a countersunk rim arranged in an assembly A represented according to the non-limiting embodiment illustrated by the stack of two sheets. The fastener 100 is positioned in the hole T with the countersunk head 121 of the outer body 120 bearing on the countersunk rim of the hole T.

For greater clarity, only the end of the tool O is illustrated. The latter is engaged on the protruding end of the fastener 100 on the accessible side of the assembly A.

The end of the tool O combines a setting member 200 cooperating with the detachable portion 113 of the head 112 of said rod 110 and a setting-verification member 300 cooperating with the detachable portion 122 of the head 121 of the outer body 120.

The setting-verification member 300 comprises a body adopting a cylindrical outer shape with a hollow core 310 is also cylindrical and receives via a pivot link a portion of the setting member 200.

The hollow core 310 opens at the end of the body of the verification member 300 oriented towards the fastener 100. This end is preformed with a recess 311 with which the detachable portion 122 of the head 121 of the outer body 120 cooperates for retaining during the setting and for driving during the setting verification.

This recess 311 is preformed in the central rear part with a hollow 312 allowing the detachable portion 113 of the rod to cooperate with the distal portion of the setting member 200 which is itself preformed with a recess 210 set back with respect to the recess 311 of the verification member 300.

According to the preferred but non-limiting embodiment illustrated, said setting member 200 comprises an ejector punch 320 that exerts by means of a spring 321, an axial thrust against the detachable portion 113 during the ejection phase. During the phases of setting and of setting-verification, the punch remains in a retracted position.

According to a preferred but non-limiting embodiment, the setting method involves carrying out the following operations:
positioning the fastener 100 at the end of the tool O then positioning the fastener 100 in a hole T passing through an assembly A by means of said tool O,
maintaining the outer body 120 in position by the tool O,
creating a bulb for fastening the assembly by rotation of the rod 110, a rotation implemented by the tool O,
breaking the detachable portion 113 of the head 112 of the rod 110,
breaking the detachable portion 122 of the head 121 of the outer body 120 for verification of the proper setting,
evacuation of the detachable parts 113 and 122.

This setting is described below in association with the succession of FIGS. 2a to 2g.

According to another embodiment, the fastener 100 is installed in the hole T before the end of the tool O cooperates with it.

As illustrated in the drawing of FIG. 2a, the setting tool O cooperates with the protruding end of the fastener 100 so that its setting member 200 cooperates with the detachable portion 113 of the rod 110 and the verification member 300 cooperates with the detachable portion 122 of the outer body 120.

As illustrated in the drawing of FIG. 2b, a movement of rotation F1 is imparted on the setting member 200 which drives the rod 110 in rotation. The verification member 300 remains stationary during this rotation in order to propose a counter-torque. Due to the helical link between the end 111 of the rod 110 and the portion 142 with an inner thread of the mobile portion 140, the rotation of the rod 110 drives the mobile part 140 of the outer body 120 in translation F2 towards the fixed part 130. The interactions of the friction type between said rod 110 and said head 121 of the outer body also engender a resistant torque opposed to the motor torque of installation on said rod 110. Thus, the counter-torque undergone by the detachable portion 122 of said head 121 can vary in a wide range.

As illustrated in the drawings of FIGS. 2c and 2d, the continuation of the movement of rotation according to the arrow F1 leads the mobile part 140 to be deformed by progressively forming a bulb 143 that comes in contact with the blind side of the assembly A as illustrated in the drawing of FIG. 2e. As illustrated, this bulb forms completely in the air before clamping the parts to be assembled. The torque necessary to deform the bulb is transmitted largely to the body. The counter-torque is thus high from the beginning of the setting which constitutes an additional difficulty.

At this stage, the bearing of the bulb 143 leads the rotation to exert a clamping creating a torsional stress at the rupture groove 114 which, after a predefined threshold S1 is exceeded, breaks. The detachable portion 113 thus detaches from the head 112 of the rod 110. The rotation according to the arrow F1 of the rod 110 stops. The detachable part 113 remains in the tool O.

A movement of impact rotation (arrow F3) is then transmitted to the verification member 300 which transmits it to the outer body 120 via the detachable part 122 according to a movement of rotation arrow F3. The thinned part or rupture groove 123 breaks starting when a stress threshold S2 is exceeded. If this rotation has the consequence illustrated namely a rupture of the thinned part 123, the fastener 100 is considered to be properly installed since the tension installed in the assembly is judged to be sufficient and a smooth surface state is obtained.

If this rotation has the non-illustrated consequence of a rotation of the fastener 100 in the hole T, the fastener 100 is considered to be poorly set since the tension installed in the assembly is not sufficient to lead to the rupture of the groove 123. The poorly set fastener is thus removed.

To do this, the fastener can be destroyed by piercing. The non-broken part of the outer body can then be used as a guide for centering and/or obtaining a reference for the piercing tool.

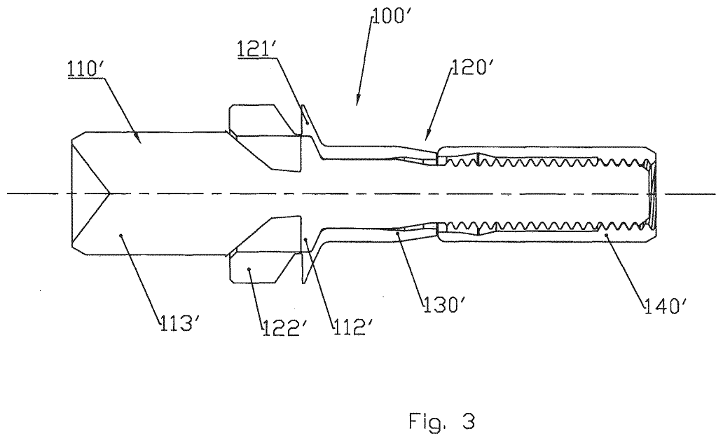

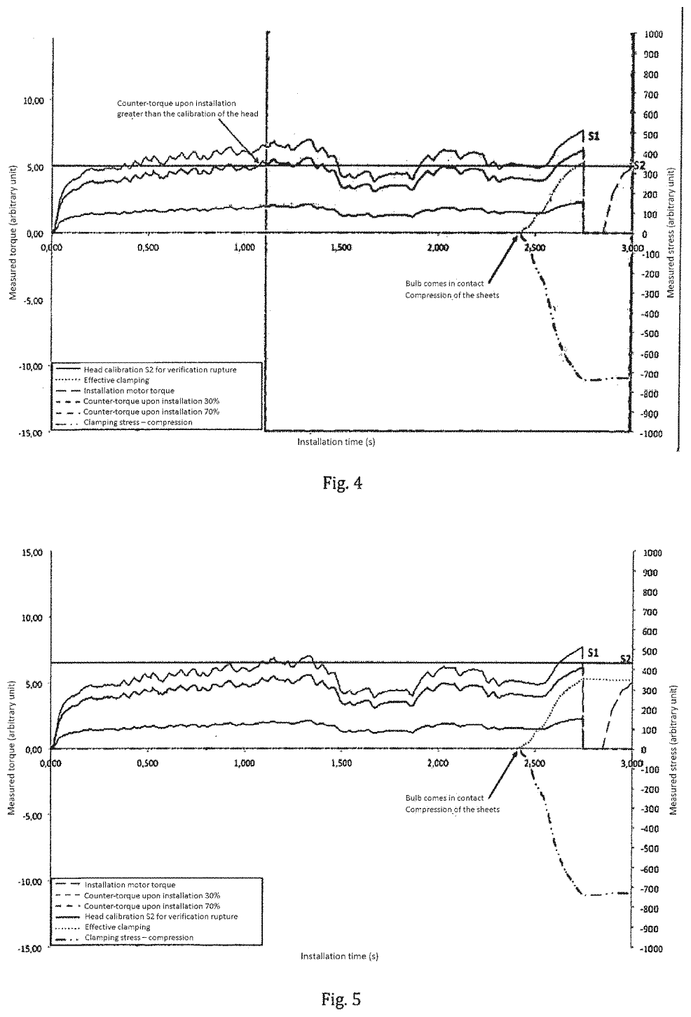

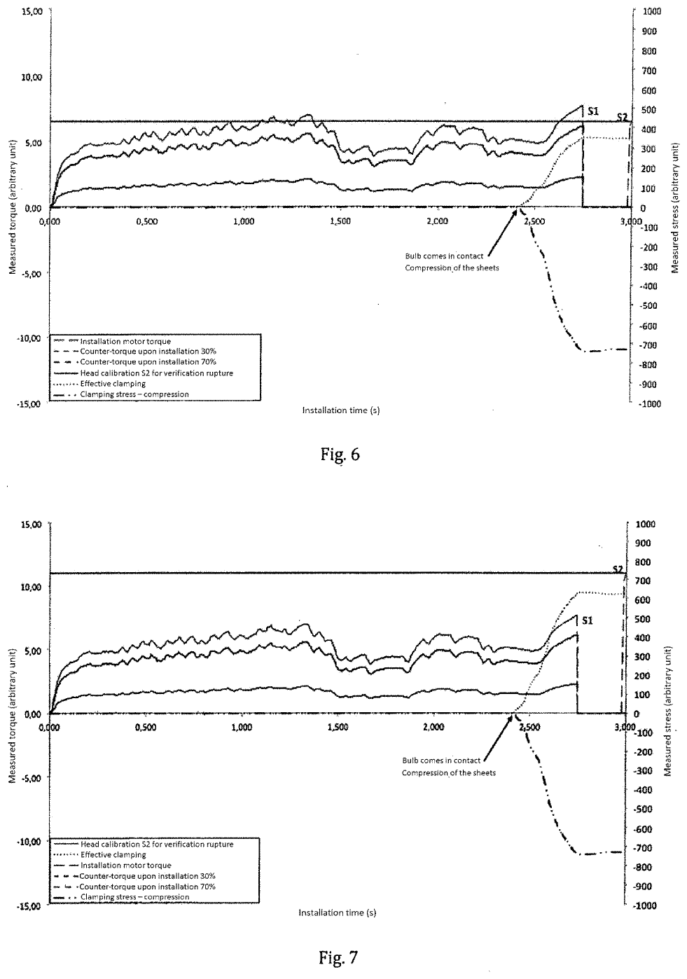

As illustrated in the drawing of FIG. 2f, the detachable parts 113 and 122 are ejected from the tool O by the ejector 320. In order to facilitate this ejection, a different embodiment of a blind fastener 100′ is proposed and illustrated by the drawing of FIG. 3. To do this, in this new embodiment, the blind fastener labelled 100′ adopts the following differences with regard to the blind fastener 100 described above:
the detachable portion 113′ of the head 112′ of the rod 110′ is preformed in such a way as to form an axial support so that the movement in translation of the ejector imparted on the detached portion 113′ causes a contact with the detachable portion 122′ of the head 121′ of the outer body 120′.

According to the embodiment illustrated, the detachable portion 113′ has a dimension greater than that of the hollow core passing through the outer body 120′ in such a way as to guarantee said contact.

As illustrated in the drawings of FIGS. 2g and 2h, the fastener 100 has a clean rupture once set. The aerodynamic fingerprint is small and a cosmetic appearance is substantially smooth. Indeed, the remainder of the broken parts does not exceed 150 microns with respect to the surface of the assembly A in accordance with the goals of the invention.

It is understood that the tool and the blind fastener, which have just been described and shown above, were described and shown with a view to a disclosure rather than a limitation. Of course, various arrangements, modifications and improvements can be made to the examples above, without going beyond the context of the invention.

1. A method for setting a blind fastener (100) comprising a rod (110) onto which an outer body (120) is fitted,
the outer body (120) comprising a head (121) and a detachable portion (122) connected to said head (121) by means of a thinned portion (123) of the outer body (120),
the outer body (120) comprising one or more parts,
said outer body (120) comprising a deformable portion for creating a bulb under the action of the rod (110),
the rod (110) comprising a rupture groove (114) which breaks from a predefined stress threshold,
the setting method involving carrying out the following operations:
positioning the fastener (100) in a hole (T) passing through an assembly,
maintaining the fastener (100) in the hole (T),
creating a bulb for fastening the assembly,
rupture of the rod (110),
rupture of the detachable portion (123) of the head (121) of the outer body (120),
the method comprising:
driving the rod (110) without jolts for creating the bulb until rupture of the rod (110) at the rupture groove (114) while retaining the detachable portion (122) of the head (121) of the outer body (120),
impact driving in rotation by producing a significant dynamic stress in a very short time, by subjecting to at least one impact in a direction of rotation, the detachable portion (123) of the head (121) of the outer body (120) in order to exert a torsional stress for rupture of the thinned portion (123) of the outer body (120), the rupture resulting from a proper installation and the absence of rupture resulting from a poor installation.

2. The method according to claim 1, wherein the creation of the bulb until rupture of the rod (110) at the rupture groove (114) while retaining the detachable portion (122) of the head (121) of the outer body (120), is carried out by driving said rod (110) in rotation without jolts.

3. The method according to claim 1, wherein the significant stress is a stress corresponding to at least two times the stress necessary to break the thinned linking portion (123) connecting the detachable portion (122) to the head (121) of the outer body (120) and the very short time is a time of less than one second.

4. A setting tool (O) to implement the method according to claim 1,
comprising a setting member (200) cooperating with said rod (110) and a setting-verification member (300) cooperating with said head (121) of the outer body (120),
the setting member (200) having an action on the rod (110) for creating the bulb until rupture of the rod (110) at the rupture groove (114),
the setting-verification member (300) retaining the detachable portion (122) of the head (121) of the outer body (120) during the action of the setting member (200) on the rod (110),
the setting-verification member (300) subjecting the detachable portion (122) of the head (121) of the outer body (120) to a torsional stress by driving in rotation of the impact type which allows the production of a significant dynamic stress produced in a very short time by subjecting said detachable portion (122) of the head (121) of the outer body (120) to at least one impact in a direction of rotation for rupture of the thinned portion (123) of the outer body (120), the rupture resulting from a proper installation and the absence of rupture resulting from a poor installation.

5. The tool (O) according to claim 4, wherein the setting member (200) ensures a rotation of the rod (110) for creating the bulb by screwing until rupture of the rod (110) at the rupture groove (114).

6. The tool (O) according to claim 4, wherein the setting member (200) is moved by an electric or pneumatic motor.

7. The tool (O) according to claim 4, wherein the setting-verification member (300) is moved by an electric or pneumatic motor.

8. The tool (O) according to claim 4, further comprising a single motor driving the setting member (200) and the setting-verification member (300) in a distinct manner by means of a suitable reduction sub-assembly.

9. The tool (O) according to claim 4, wherein the setting member (200) drives the setting-verification member (300) by means of a suitable reduction assembly.

10. The tool (O) according to claim 4, wherein the setting-verification member (300) comprises an angle of “free” rotation that is between 60° and 240°.

11. A blind fastener (100) comprising a rod (110) onto which an outer body (120) is fitted,
the outer body (120) comprising a head (121) and a detachable portion (122) connected to said head (121) by means of a thinned portion (123) of the outer body (120),
the outer body (120) comprising one or more parts,
said outer body (120) comprising a deformable portion for creating a bulb under the action of the rod (110),
the rod (110) comprising a head (112) and a detachable portion (113) of the rod head connected to said head (112) by a rupture groove (114) which breaks from a predefined stress threshold,
said thinned portion (123) of the outer body (120) connecting the detachable portion (122) to said head (121) being dimensioned in such a way as to
resist the counter-torque that it undergoes during the creation of the bulb by rotation of the rod (110) until the rupture of the rupture groove (114) of the rod (110), and
break during an impact driving if the fastener (100) is properly installed,
wherein the detachable portion (113) of the head (112) of the rod (110) is preformed in such a way as to form an axial support so that a movement in translation applied to the detachable portion (113) detached from the rod (110) head (112) for ejection, causes a contact with the detachable portion (122) detached from the head (121) of the outer body (120) and its own ejection.

12. The method according to claim 2, wherein the significant stress is a stress corresponding to at least two times the stress necessary to break the thinned linking portion (123) connecting the detachable portion (122) to the head (121) of the outer body (120) and the very short time is a time of less than one second.

13. A setting tool (O) implement the method according to claim 2,
comprising a setting member (200) cooperating with said rod (110) and a setting-verification member (300) cooperating with said head (121) of the outer body (120),
the setting member (200) having an action on the rod (110) for creating the bulb until rupture of the rod (110) at the rupture groove (114),
the setting-verification member (300) retaining the detachable portion (122) of the head (121) of the outer body (120) during the action of the setting member (200) on the rod (110),
the setting-verification member (300) subjecting the detachable portion (122) of the head (121) of the outer body (120) to a torsional stress by driving in rotation of the impact type which allows the production of a significant dynamic stress produced in a very short time by subjecting said detachable portion (122) of the head (121) of the outer body (120) to at least one impact in a direction of rotation for rupture of the thinned portion (123) of the outer body (120), the rupture resulting from a proper installation and the absence of rupture resulting from a poor installation.

14. A setting tool (O) implement the method according to claim 3,
comprising a setting member (200) cooperating with said rod (110) and a setting-verification member (300) cooperating with said head (121) of the outer body (120),
the setting member (200) having an action on the rod (110) for creating the bulb until rupture of the rod (110) at the rupture groove (114),
the setting-verification member (300) retaining the detachable portion (122) of the head (121) of the outer body (120) during the action of the setting member (200) on the rod (110),
the setting-verification member (300) subjecting the detachable portion (122) of the head (121) of the outer body (120) to a torsional stress by driving in rotation of the impact type which allows the production of a significant dynamic stress produced in a very short time by subjecting said detachable portion (122) of the head (121) of the outer body (120) to at least one impact in a direction of rotation for rupture of the thinned portion (123) of the outer body (120), the rupture resulting from a proper installation and the absence of rupture resulting from a poor installation.

15. The tool (O) according to claim 5, wherein the setting member (200) is moved by an electric or pneumatic motor.

16. The tool (O) according to claim 5, wherein the setting-verification member (300) is moved by an electric or pneumatic motor.

17. The tool (O) according to claim 5, further comprising a single motor driving the setting member (200) and the setting-verification member (300) in a distinct manner by means of a suitable reduction sub-assembly.

18. The tool (O) according to claim 5, wherein the setting member (200) drives the setting-verification member (300) by means of a suitable reduction assembly.

19. The tool (O) according to claim 5, wherein the setting-verification member (300) comprises an angle of “free” rotation that is between 60° and 240°.

20. A setting tool (O) implement the method according to claim 1,
comprising a setting member (200) cooperating with said rod (110) and a setting-verification member (300) cooperating with said head (121) of the outer body (120),
the setting member (200) having an action on the rod (110) for creating the bulb until rupture of the rod (110) at the rupture groove (114),
the setting-verification member (300) retaining the detachable portion (122) of the head (121) of the outer body (120) during the action of the setting member (200) on the rod (110),
the setting-verification member (300) subjecting the detachable portion (122) of the head (121) of the outer body (120) to a torsional stress by driving in rotation of the impact type which allows the production of a significant dynamic stress produced in a very short time by subjecting said detachable portion (122) of the head (121) of the outer body (120) to at least one impact in a direction of rotation for rupture of the thinned portion (123) of the outer body (120), the rupture resulting from a proper installation and the absence of rupture resulting from a poor installation.
